(19) United States
(12) Patent Application Publication
(10) Pub. No.: US 2009/0205616 A1
(43) Pub. Date: Aug. 20, 2009

(54) DEVICE AND METHOD FOR REGULATING A VOLUMETRIC FLOW OF FUEL IN A LOW-PRESSURE CIRCUIT SYSTEM FOR AN INTERNAL COMBUSTION ENGINE

(76) Inventor: Stanislaw Bodzak, Elsbethen (AT)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/305,563

(22) PCT Filed: Jul. 5, 2007
(86) PCT No.: PCT/EP2007/056831

§ 371 Date: Dec. 18, 2008

(30) Foreign Application Priority Data
Aug. 9, 2006 (DE) 102006037174.7

(51) Int. Cl. F02M 37/00

(52) U.S. Cl. 123/512; 123/514

(57) ABSTRACT

The invention relates to a device for regulating a fuel volume flow in a low-pressure circuit system for an internal combustion engine with a tail for providing the fuel, from which tank the fuel can be supplied via a feed line to a high-pressure pump by a feed pump. A fuel return line is also provided from the feed line, which fuel return line has a zero-feed throttle for throttling the returned fuel. In series with the zero-feed throttle is an overflow valve which interrupts the return of the fuel in the fuel return line during the starting phase of the internal combustion engine, and enables the return of the fuel during operation of the internal combustion engine. A device and a method for regulating a fuel volume flow in a low-pressure circuit system are therefore created, which device has a simple construction and permits a reliable starting phase at low feed volumes.

The present invention relates to a device and a method for regulating a volumetric flow of fuel in a low-pressure circuit system for an internal combustion engine, with the defining characteristics of the preambles to claim 1 and claim 9.

### PRIOR ART

Low-pressure circuit systems of this kind for supplying the volumetric flow of fuel from a tank to a common rail injection system of an internal combustion engine are sufficiently known from the prior art. Systems of this kind regulate the supply of fuel from a tank to a metering unit and to the high-pressure pump, which provides the fuel with a high pressure in the common rail system.

Patent DE 196 18 707 C2 has disclosed a method for regulating the volumetric flow of fuel that a supply pump supplies to a high-pressure pump connected to a high-pressure reservoir that supplies fuel to at least one injection valve; the fuel has a predetermined pressure that is set by a high-pressure valve connected to the high-pressure reservoir. In this system, the high-pressure valve is provided in order to discharge fuel once it reaches a set fuel pressure; this occurs as a function of the discharged fuel quantity, with the volumetric flow of fuel being regulated through a direct variation of the fuel pressure between the supply pump and the high-pressure pump. For this purpose, an adjustable quantity of the fuel supplied by the supply pump is discharged; this occurs through a direct variation of a cross section of a connecting line between the supply pump and the high-pressure pump. The basic problem of supplying the fuel to a metering unit and to a high-pressure pump lies in the fact that when the internal combustion engine is started, due to the dimensioning of the supply pump, sufficient supply pressure is unavailable because it is conveyed back to the talk by means of a zero-feed throttle or the like. An adapted supply of fuel is only possible during normal operation of the internal combustion engine, making it necessary to provide a high-pressure valve that opens or closes depending on whether the internal combustion engine is being operated in the normal mode or is in the starting phase.

According to this embodiment, however, the problem is that this requires a high-pressure valve that must be brought into an operational connection with a pressure control valve. Because of the very high pressures of the fuel, however, reliably switching the high-pressure valve involves considerable difficulties.

The object of the present invention, therefore, is to provide a regulation of a volumetric flow of fuel in a low-pressure circuit system that is simple in design and permits a reliable starting phase at low supply volumes.

### DISCLOSURE OF THE INVENTION

This object is attained by a device and a method for regulating a volumetric flow of fuel in a low-pressure circuit system, having the defining characteristics of the respective preambles to claim 1 and claim 9. Advantageous modifications of the invention are disclosed in the dependent claims.

The invention includes the technical teaching that the fuel return line also includes an overflow valve, which is serially connected to the zero-feed throttle; this overflow valve interrupts the return of the fuel in the fuel return line during the starting phase of the internal combustion engine and enables the return of fuel during the operation of the internal combustion engine.

In this case, the invention is based on the concept that the volumetric flow of fuel through the fuel return line can be enabled or interrupted as a function of the operating state of the internal combustion engine. The supply pump supplies the fuel to a metering unit, then a high-pressure pump compresses it to a correspondingly high pressure level and supplies it to the common rail system. In the course of this, the fuel passes through a first supply line and a second supply line, neither of which supply lines contains a throttle, which would require a higher pumping power of the supply pump. The fuel return line is provided as a branch extending from the second supply line and returns excess fuel from the second supply line to the intake side of the supply pump or to the fuel tank.

During the starting of the internal combustion engine, the power of the supply pump is low since the supply pump is only able to supply a limited volumetric flow of fuel as a function of the speed of the internal combustion engine. The metering unit is not 100% leak-proof and a return via the zero-feed throttle is very critical. Only at a higher speed, e.g. speeds greater than 800 rpm, is the pumping capacity of the supply pump sufficiently high to supply enough fuel to the metering unit and the high-pressure pump to permit the overflow valve to switch over into an open position and part of the fuel to return via the zero-feed throttle to the intake side of the supply pump and to the tank. The return of the fuel to the tank is necessary during engine braking maneuvers. i.e. in trailing throttle mode, because the speed is high, but no injection should be taking place.

The design according to the invention makes it possible, through a simple closing during the starting phase of the internal combustion engine and an opening during the operation of the engine, to interrupt and subsequently enable the volumetric flow of fuel through the fuel return line. The resulting advantage is the elimination of a high-pressure valve that is required to control a pressure control valve, thereby also eliminating the originally complex embodiment of the pressure control valve. It is also no longer necessary to provide a throttle between the supply pump and the high-pressure pump, which would require an unnecessary pumping power of the supply pump and would result in avoidable losses. This permits the use of a smaller supply pump, thereby offering advantages in terms of costs and weight.

According to an advantageous exemplary embodiment of the invention, the overflow valve is embodied in the form of a slide valve and includes a valve slider on which a control pressure surface is provided; the control pressure surface delimits a control pressure chamber. In addition, the overflow valve includes a compression spring, which moves the valve slider in a closing direction; in the closed position, the valve slider closes the fuel return line. By means of this arrangement of the control pressure chamber and the compression spring, the overflow valve functions as a monostable slide valve, which remains in the closed position when no pressure is exerted on a control pressure surface and can only be switched into an operating position when a pressure is exerted on the control pressure chamber and therefore on the control pressure surface.

The control pressure chamber is advantageously fluidically connected to the first supply line; when pressure is exerted on the control pressure chamber by the supply pressure of the supply pump, the valve slider can be moved into an operating position counter to the spring force of the compression spring and in the operating position, the valve slider opens the fuel return line. The overflow valve in the fuel return line is therefore switched by means of the pressure in the first supply line, which depends on the operating state of the internal combustion engine. This advantageously requires no external electromagnetic triggering of the overflow valve since the fluidic connection of the control pressure chamber to the first supply line permits a reliable switching of the overflow valve between a closed position in the starting phase of the internal combustion engine and an operating position in the operating phase of the engine.

In this case, the spring force of the compression spring is designed to be greater than the resulting force of the pressure exerted on the control pressure surface by the supply pressure of the supply pump during the starting phase of the internal combustion engine so that the valve slider remains in the closed position and the fuel return through the fuel return line is interrupted. However, after the starting phase, if the internal combustion engine switches into the normal operating phase, then the resulting force of the pressure exerted on the control pressure surface by the supply pressure of the supply pump is greater than the spring force of the compression spring. As a result, the valve slider is in the operating position and the fuel return through the fuel return line is enabled. This switching principle is made possible by the fact that depending on the speed of the internal combustion engine, the supply pump supplies a small quantity of fuel at a low pressure during the starting phase of the internal combustion engine and produces a high supply pressure with a high pumping power during normal operation of the engine. The excess quantity of fuel is returned to the tank through the zero-feed throttle and through the overflow valve.

Arrangement of the low pressure circuit system according to the present invention achieves a particular advantage in that the supply pump, in terms of a maximum required pumping power, can be made comparatively small since in the starting phase, it is possible to avoid a loss of fuel pressure in the second supply line due to the zero-feed throttle because the fuel return line is closed. During the operation of the internal combustion engine, however, the supply pump does not have to be oversized since it can now be designed to be comparatively small, even for a successful starting phase of the internal combustion engine.

For structural reasons, it is particularly advantageous that a coarse fuel filter is provided between the tank and the supply pump and a fine fuel filter is provided in the first supply line between the supply pump and the metering unit. The junction of the first supply line for fluidically connecting it to the control pressure chamber of the overflow valve is situated between the fine fuel filter and the metering unit. Consequently, the control pressure chamber of the overflow valve is also actuated with fuel that has already been finely filtered.

The present invention also relates to a method for regulating a volumetric flow of fuel in a low-pressure circuit system for an internal combustion engine equipped with a tank for supplying the fuel; a supply pump supplies the fuel from the tank via a first supply line to a metering unit by means of which the fuel is supplied via a second supply line to a high-pressure pump, and part of the fuel is returned to the intake side of the supply pump via a fuel return line; the fuel return line includes a zero-feed throttle for throttling the returned volumetric flow of fuel. According to the present invention, first, an overflow valve is inserted into the fuel return line, serially connected to the zero-feed throttle; in addition, during the starting phase of the internal combustion engine, the overflow valve starts out in a closed position so that the return of the fuel via the fuel return line is interrupted; and when the internal combustion engine switches into the operating mode, the overflow valve is switched into an operating position so that the fuel from the second supply line is returned to the intake side of the supply pump via the fuel return line. Accordingly, this method describes a starting procedure for an internal combustion engine equipped with a low-pressure circuit system that includes an overflow valve according to the present invention.

The method is also characterized in that the overflow valve includes a valve slider equipped with a control pressure surface that delimits a control pressure chamber, and a pressure exerted on the control pressure surface moves the valve slider into the operating position if the pressure is exerted by means of the supply pump. In this case, the pressure exerted by means of the supply pump must exceed a minimum pressure level so that when the internal combustion engine starts, the valve slider of the overflow valve moves counter to the spring force of the compression spring into an operating position. When pressure is not exerted on the control pressure chamber, the compression spring holds the valve slider in the closed position. This valve slider remains in the closed position even when the supply pump supplies only a small volumetric flow of fuel at the starting speed of the internal combustion engine. At the transition into the normal operation of the internal combustion engine, which is characterized by a minimum speed of for example 800 rpm, the supply pressure of the supply pump achieves a minimum pressure level so that the valve slider switches into the operating position. The switch into the operating position in his case occurs in opposition to the spring force of the compression spring and assures an operating pressure of approximately 5 to 7 bar.

According to another exemplary embodiment of the present invention, the supply pump is operated as a function of the speed of the internal combustion engine; at a low speed during the starting phase of the internal combustion engine, the overflow valve remains in the closed position due to the low delivery rate and starting at the idle speed of the internal combustion engine, the supply pressure of the supply pump reaches a value to switch the overflow valve into the operating position by exerting pressure on the control pressure surface.

Other measures that improve the invention will be illustrated in greater detail below along with the description of a preferred exemplary embodiment of the invention.

### EXEMPLARY EMBODIMENT

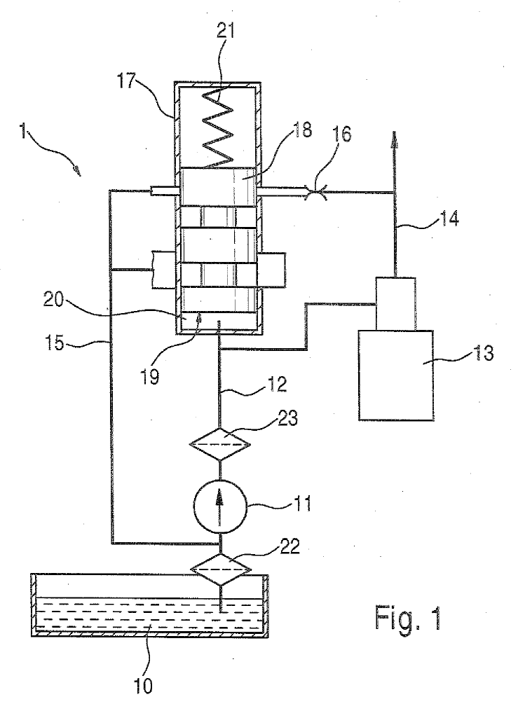

FIG. 1 shows a low-pressure circuit system for supplying fuel to an internal combustion engine, with an overflow valve according to the invention in a closed position during the starting phase of the internal combustion engine; and

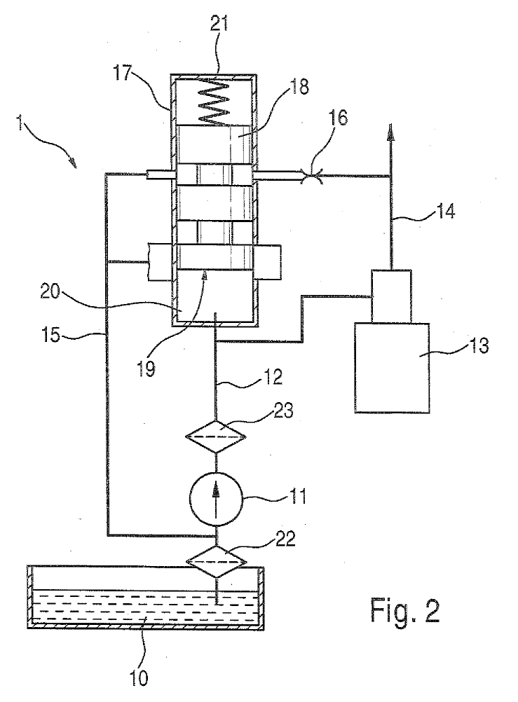

FIG. 2 shows a low-pressure circuit system for supplying fuel to an internal combustion engine, with an overflow valve according to the invention in an operating position during the operation of the internal combustion engine.

The low-pressure circuit system 1 shown in FIG. 1 serves to supply fuel from a tank 10 to a common rail system for injecting fuel into the combustion chamber of an internal combustion engine. A supply pump 11, which draws the fuel through a coarse fuel filter 22, is provided to supply the fuel from the tank 10. Downstream of the supply pump 11, the fuel is conveyed through a fine fuel filter 23 and is supplied to a first supply line 12. The supply line 12 leads to a metering unit, which supplies the fuel to the common rail system via a second supply line 14.

From the second supply line 14, the fuel can be returned via a zero-feed throttle 16 to the intake side of the supply pump 11 or to the tank 10. This is particularly required if the internal combustion engine is in normal operating mode and is therefore operating at a correspondingly elevated speed. The quantity of fuel supplied in the second supply line is greater than that which must be supplied to the common rail system by the high-pressure pump. By contrast, in the starting phase, as shown in FIG. 1, the supply pump 11 is not operated at full speed since it is as a rule driven by the internal combustion engine itself. The available volumetric flow of fuel and the available fuel pressures in the first supply line 12 and in the second supply line 14 in this case are comparatively low. In order to then increase the pressure in the second supply line during the starting phase of the internal combustion engine, the discharge of fuel via the fuel return line 15 is initially interrupted by an overflow valve 17 in order to provide a high pressure of the fuel in the second supply line 14 even at low engine speed and low supply volumes of the supply pump 11.

During the starting phase, the overflow valve 17 is in a closed position in which a valve slider 18, supported in an axially sliding fashion, closes the fuel return line 15. A compression spring 21 presses the valve slider 18 into the closed position. A branch leading from the first supply line 12 fluidically connects it to the control pressure chamber 20. The control pressure chamber 20 is delimited by the control pressure surface 19, which, when pressure is exerted on it, is able to move the valve slider 18 into an operating position in opposition to the compression spring 21. If the low-pressure circuit system is in the starting phase of the internal combustion engine as shown in FIG. 1, then the overflow valve 17 closes the fuel return line 15 so that no fuel can be returned from the second supply line 14 via the zero-feed throttle 16 to the tank 10 or to the intake side of the supply pump 11.

FIG. 2 shows the low-pressure circuit system 1 in the operating position. As has already been described in conjunction with FIG. 1, the supply pump 11 draws the fuel from the tank 10 through a first coarse fuel filter 22. The fuel is supplied by the supply pump 11 to a first supply line 12 through a fine fuel filter and then travels via the first supply line 12 to a metering unit 13. The metering unit 13 conveys the fuel via a second supply line 14 to a common rail system, which is not shown here.

Because of the position of the valve slider 18, the fuel return line 15 is open so that the fuel can be returned from the second supply line 14 via the zero-feed throttle 16 to the intake side of the supply pump 11. If the low-pressure circuit system 1 is in the position shown in FIG. 2 during the operation of the internal combustion engine, then the supply pump 11 supplies a large quantity of fuel so that, as a result of the connection of the first supply line 12 to the control pressure chamber 20, a higher pressure is exerted on this chamber. The exertion of a high pressure on the control pressure chamber 20 simultaneously causes the valve slider 18, due to the presence of its control pressure surface 19 delimiting the chamber, to move into the operating position in opposition to the force of the compression spring 21. Due to the presence of corresponding recesses in the valve slider 18, can be returned from the zero-feed throttle 16 through these recesses and via the fuel return line 15.

In order to assure the reliable functioning of the low-pressure circuit system 1 with an overflow valve 17 according to the invention, the size of the overflow valve 17 and the area of the control pressure surface 19 are matched to the pressure level of the supply pump 11 so that the valve slider 18 is switched into the operating position only when the internal combustion engine switches into the normal operating mode. According to the present embodiment, this can also occur through an appropriate selection of the spring stiffness of the compression spring 21. In addition, a prestressing pressure of the compression spring 21 can be adjusted by means of an adjusting screw so that the movement of the valve slider 18 from the closed position into the operating position can be adapted to the corresponding engine speed.

The scope of the present invention is not limited to the exemplary embodiment described above. There are instead a number of conceivable variants that make use of the version shown even in fundamentally different embodiments.

1-12. (canceled)

13. A device for regulating a volumetric flow of fuel in a low-pressure circuit system for an internal combustion engine, comprising:
a tank for supplying the fuel, from which a supply pump is able to supply the fuel via a supply line to a high-pressure pump;
a fuel return line having a zero-feed throttle for throttling the returned fuel; and
an overflow valve serially connected to the zero-feed throttle in the fuel return line, wherein during the starting phase of the internal combustion engine, the overflow valve interrupts return of the fuel in the fuel return line and during operation of the internal combustion engine, the overflow valve enables the return of the fuel.

14. The device as recited in claim 13, wherein the overflow valve is embodied in the form of a slide valve and includes a valve slider on which a control pressure surface is provided, and the control pressure surface delimits a control pressure chamber.

15. The device as recited in claim 14, wherein the overflow valve includes a compression spring which moves the valve slider into a closed position, and in the closed position, the valve slider closes the fuel return line.

16. The device as recited in claim 14, wherein the control pressure chamber is fluidically connected to a first supply line, when a pressure is exerted on the control pressure chamber by the supply pressure of the supply pump, the valve slider is brought into an operating position counter to a spring force of the compression spring, and in the operating position, the valve slider opens the fuel return line.

17. The device as recited in claim 15, wherein a spring force of the compression spring is greater than a resulting force of the pressure exerted on the control pressure surface by a supply pressure of the supply pump during a sting phase of the internal combustion engine so that the valve slider remains in the closed position and the fuel return via the fuel return line is interrupted.

18. The device as recited in claim 16, wherein the spring force of the compression spring is greater than a resulting force of the pressure exerted on the control pressure surface by a supply pressure of the supply pump during a starting phase of the internal combustion engine so that the valve slider remains in the closed position and the fuel return via the fuel return line is interrupted.

19. The device as recited in claim 15, wherein a resulting force of pressure exerted on the control pressure surface by a supply pressure of the supply pump during operation of the internal combustion engine is greater than a spring force of the compression spring so that the valve slider assumes the operating position and the fuel return via the fuel return line is enabled.

20. The device as recited in claim 16, wherein a resulting force of pressure exerted on the control pressure surface by a supply pressure of the supply pump during operation of the internal combustion engine is greater than the spring force of the compression spring so that the valve slider assumes the operating position and the fuel return via the fuel return line is enabled.

21. The device as recited in claim 13, wherein a coarse fuel filter is situated in a first supply line between the tank and the supply pump.

22. The device as recited in claim 14, wherein a coarse fuel filter is situated in a first supply line between the tank and the supply pump.

23. The device as recited in claim 17, wherein a coarse fuel filter is situated in a first supply line between the tank and the supply pump.

24. The device as recited in claim 19, wherein a coarse fuel filter is situated in a first supply line between the tank and the supply pump.

25. The device as recited in claim 13, wherein a fine fuel filter is situated in a first supply line between the supply pump and the metering unit, and a branch from the first supply line for the fluidic connection to the control pressure chamber is situated between the fine fuel filter and the metering unit.

26. The device as recited in claim 14, wherein a fine fuel filter is situated in a first supply line between the supply pump and the metering unit, and a branch from the first supply line for the fluidic connection to the control pressure chamber is situated between the fine fuel filter and the metering unit.

27. The device as recited in claim 17, wherein a fine fuel filter is situated in a first supply line between the supply pump and the metering unit, and a branch from the first supply line for the fluidic connection to the control pressure chamber is situated between the fine fuel filter and the metering unit.

28. The device as recited in claim 19, wherein a fine fuel filter is situated in a first supply line between the supply pump and the metering unit, and a branch from the first supply line for the fluidic connection to the control pressure chamber is situated between the fine fuel filter and the metering unit.

29. A method for regulating a volumetric flow of fuel in a low-pressure circuit system for an internal combustion engine equipped with a tank for supplying a fuel, from which a supply pump supplies the fuel via a supply line to a high-pressure pump and part of the fuel is returned via a fuel return line the fuel return line includes a zero-feed throttle for throttling the returned volumetric flow of fuel, the method comprising the steps of:
inserting an overflow valve into the fuel return line to be serially connected to the zero-feed throttle;
setting a closed position of the overflow valve during a starting phase of the internal combustion engine so that return of the fuel via the fuel return line is interrupted; and
switching the overflow valve into an operating position when the internal combustion engine switches from the starting phase into an operating phase, so that the fuel is returned from a second supply line via the fuel return line to an intake side of the supply pump.

30. The method as recited in claim 29, wherein the overflow valve includes a valve slider with a control pressure surface that delimits a control pressure chamber, and a pressure exerted on the control pressure surface moves the valve slider into an operating position, the pressure being exerted by means of the supply pump.

31. The method as recited in claim 30, wherein during starting of the internal combustion engine, a compression spring holds the valve slider in the closed position and the valve slider switches into the operating position only when the supply pump acts on a control pressure surface of the valve slider with a minimum pressure in opposition to a spring force of the compression spring.

32. The method as recited in claim 29, wherein the supply pump is operated as a function of the speed of the internal combustion engine and at a low speed during the starting phase of the internal combustion engine, the overflow valve remains in the closed position due to a lower supply pressure and it is only starting at an idle speed of the internal combustion engine that the supply pressure of the supply pump reaches a value to switch the overflow valve into the operating position through exertion of pressure on the control pressure surface.
